(19) United States
(12) Patent Application Publication
(10) Pub. No.: US 2015/0048998 A1
(43) Pub. Date: Feb. 19, 2015

(54) METAL PLATE ANTENNA

(71) Applicant: AUDEN TECHNO CORP., TAOYUAN COUNTY (TW)

(72) Inventors: SHIH-CHI LAI, MIAOLI COUNTY (TW); PENG-HAO JUAN, TAIPEI CITY (TW); CHENG-MIN YANG, KAOHSIUNG CITY (TW)

(73) Assignee: AUDEN TECHNO CORP., TAOYUAN COUNTY (TW)

(21) Appl. No.: 13/969,028

(22) Filed: Aug. 16, 2013

(51) Int. Cl. H01Q 1/36

(52) U.S. Cl. CPC H01Q 1/36
USPC 343/906

(57) ABSTRACT

The present disclosure provides a metal plate antenna comprising a radiating portion and at least two grounding pins. The radiating portion is a metal plate and the two ends of the radiating portion are a first end and a second end respectively. The first end and the second end are bended towards the same direction and are perpendicular to the radiating portion. One of the first end and the second end is for the feeding end. At least one of the first end and the second end has at least a plug-foot. The plug-foot is used for plugging into the inserting hole of a circuit board. At least two grounding pins are vertical connected to the radiating portion and one of the grounding pins is used to be connected with the grounding of the circuit board.

### BACKGROUND OF THE INVENTION

1. Field of the Invention

The instant disclosure relates to an antenna; in particular, to a metal plate antenna.

2. Description of Related Art

In conventional, the antenna applying the surface mount technology (SMT) could be made by manufacturing process of ceramics or printed circuit board (PCB). The antenna made by the printed circuit board has higher dielectric loss, and the ceramic antenna has narrow bandwidth. Additionally, the antenna made by metal objects applying the surface mount technology needs to overcome the supporting issues when the antenna is disposed on the substrate. The conventional metal plate antenna utilizes non-conductive support (e.g. sponge) to make the metal antenna stand on the substrate stably. However, the non-conductive support, such as the sponge, usually is not heat-proof, thus the non-conductive support could not bear the high temperature of the tin furnace while applying the surface mount technology.

Please refer to FIG. 1 showing a schematic diagram of a conventional metal plate antenna applied with the surface mount technology. The grounding pin 101 of the conventional metal plate antenna 1 is designed to have two bendings 101a and 101b, and the end of the grounding pin 101 has a sufficient contact area to be contacted with the touch pad 100a of the circuit board 100. Thus, the antenna 1 could be supported well and could be suitable for the surface mount technology. However, the bending angle of the bendings 101a and 101b of the metal plate antenna 1 may not be 90 degrees as designed due to the resilience of the material. For example, the bending angle of the bending 101a′ or the bending 101b′ of the conventional metal plate antenna 1′ would be larger than 90 degrees, thus the grounding pin 101 would not flat contact with the touch pad 100a, and the soldering would be poor (which may be solder empty or have excess solder) accordingly.

Please refer to FIG. 2A and FIG. 2B. FIG. 2A shows a schematic diagram of a conventional dual-antenna module. FIG. 2B shows a schematic diagram of a conventional dual-antenna module. The conventional dual-antenna or multi-antenna system use two or more antennas arranged on a module. According to the disposed position of the antennas on the circuit board 200, one of the antennas may needs to be rotated 180 degrees to simplify the layout of the feeding network of the antenna. For example, as shown in FIG. 2A, the antenna 2′ and the antenna 2 are identically the same, and the antenna 2′ has been rotated with 180 degrees (relative to the antenna 2). The integrated circuit (IC) 30 is connected to the feeding ends 21 of the antenna 2 and 2′ through the simple feeding network 201 and 202 respectively. On the other hand, if one of the antennas are not rotated, as shown in FIG. 2B, it means the antenna 2 on the left side of FIG. 2B is directly translated from the antenna 2′ on the right side of FIG. 2B. Meanwhile, the trace 204 connecting with the feeding end 21 of the antenna 2′ could be more complicated comparing to the trace 203 connecting with the feeding end 21 of the antenna 2, thus the complexity of the layout of the circuit board 200 may be increased. Additionally, the characteristics of radiation of the two antennas shown in FIG. 2A may be asymmetric. The characteristics of radiation of the two antennas shown in FIG. 2B may also be asymmetric; meanwhile, the layout of the circuit board may be more complicated.

### SUMMARY OF THE INVENTION

The object of the instant disclosure is to offer a metal plate antenna which has at least two bending structures for standing on the circuit board. The plug-foot of the metal plate antenna is for positioning Additionally, the metal plate antenna provides at least two feeding ends.

In order to achieve the aforementioned objects, according to an embodiment of the instant disclosure, a metal plate antenna is offered. The metal plate antenna comprises a radiating portion and at least two grounding pins. The radiating portion is a metal plate. Two ends of the radiating portion are a first end and a second end respectively. The first end and the second end are bended towards the same direction and are perpendicular to the radiating portion. One of the first end and the second end is the feeding end. At least one of the first end and the second end has at least a plug-foot, and the plug-foot is used for plugging into the inserting hole of a circuit board. The grounding pins are vertical connected to the radiating portion. One of the grounding pins is used for connecting with the grounding of the circuit board.

In summary, a metal plate antenna is offered. The metal plate antenna provides at least two feeding ends to be selected when the metal plate antenna is placed at different position on the circuit board. While applying to an antenna system having more than two antennas, all antennas can be the same metal plate antenna, and the metal plate antennas do not need to be rotated before disposing on the circuit board. The circuit layout could be more convenient and the manufacturing costs could be reduced too. The design with two or more grounding pins having the effect of adjustment related characteristics and could improve the symmetry of characteristics of radiation.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a schematic diagram of a conventional metal plate antenna applied with the surface mount technology;

FIG. 2A shows a schematic diagram of a conventional dual-antenna module;

FIG. 2B shows a schematic diagram of a conventional dual-antenna module;

FIG. 3A shows a schematic diagram of a metal plate antenna according to an embodiment of the instant disclosure;

FIG. 3B shows a side view drawing of a metal plate antenna according to an embodiment of the instant disclosure;

FIG. 3C shows a schematic diagram of a metal plate antenna according to another embodiment of the instant disclosure;

FIG. 4A shows a schematic diagram of a plug-foot of the metal plate antenna according to an embodiment of the instant disclosure;

FIG. 4B shows a schematic diagram of a plug-foot of the metal plate antenna according to an embodiment of the instant disclosure;

FIG. 4C shows a schematic diagram of a plug-foot of the metal plate antenna according to an embodiment of the instant disclosure;

FIG. 4D shows a schematic diagram of a plug-foot of the metal plate antenna according to an embodiment of the instant disclosure;

FIG. 5 shows a schematic diagram of a dual-antenna module according to an embodiment of the instant disclosure;

FIG. 6 shows a side view drawing of the dual-antenna module shown in FIG. 5 installed to a metal back plate; and

FIG. 7 shows a frequency response of S-parameters for the dual-antenna module shown in FIG. 5.

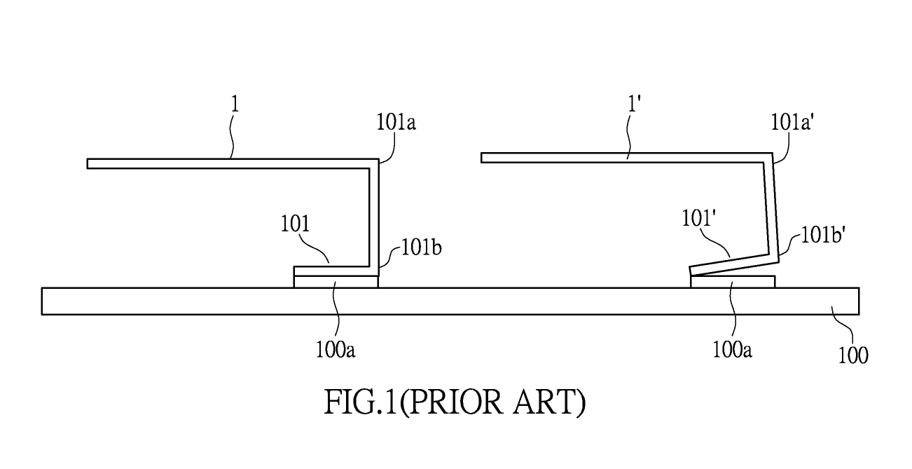

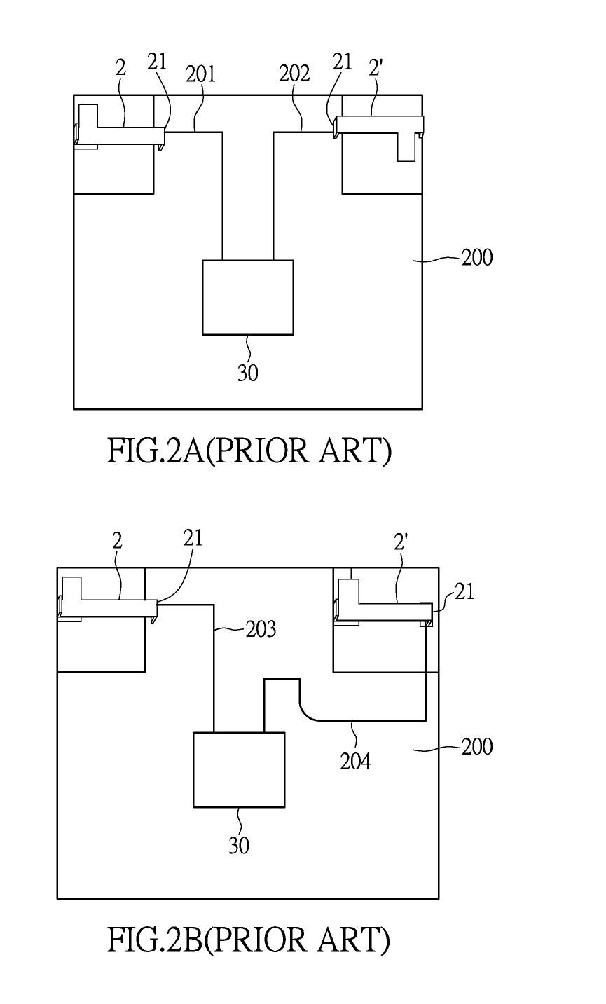

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

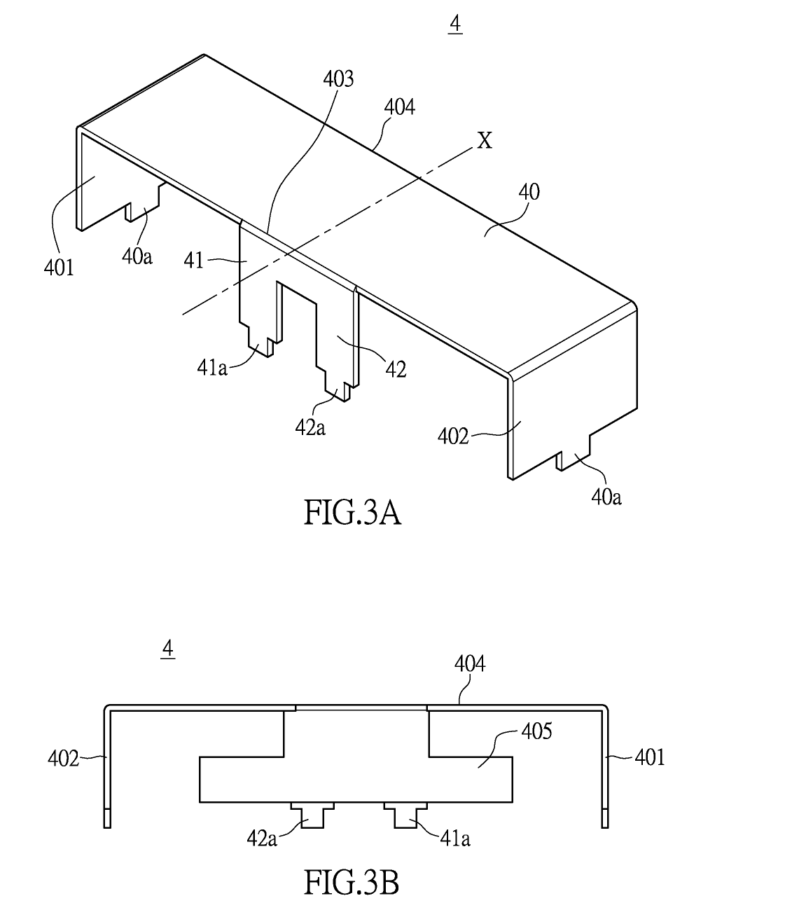

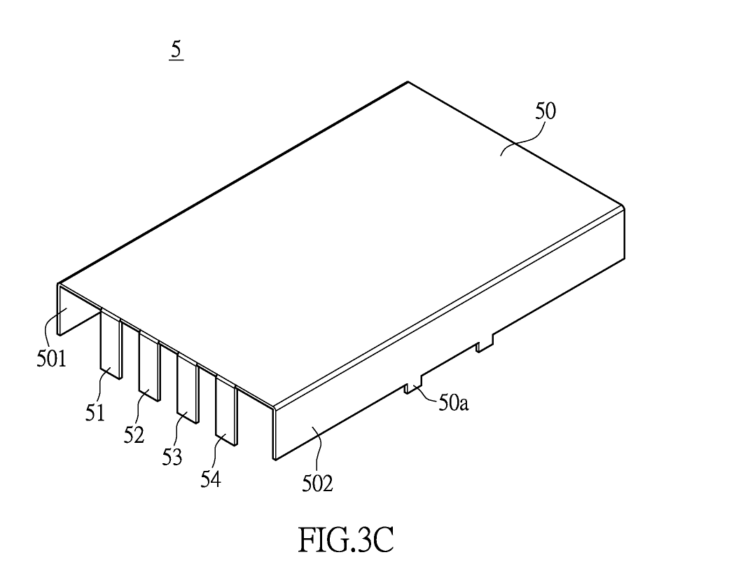

Please refer to FIG. 3A showing a schematic diagram of a metal plate antenna according to an embodiment of the instant disclosure. The metal plate antenna 4 comprises a radiating portion 40 and at least two grounding pins (41 and 42). The radiating portion 40 is a metal plate. Two ends of the radiating portion 40 are a first end 401 and a second end 402 respectively. The first end 401 and the second end 402 are bended towards the same direction and are perpendicular to the radiating portion 40. In other words, the first end 401 and the second end 402 are bended perpendicular to the plane of the radiating portion 40.

The shape of the radiating portion 40 may be a rectangle, a square, or a disk roughly, which may not irregular shape in order to improve the SMT equipment to recognize the antenna. As shown in FIG. 3A, the shape of the radiating portion 40 is a rectangle, and two ends of the long side of the radiating portion 40 are bended to be the first end 401 and the second end 402 respectively. It is worth mentioning that the radiating portion 40 may be symmetry in the reference of a symmetry axis X of the radiating portion 40, and the two symmetrical ends are the first end 401 and the second end 402 respectively. However, the radiating portion 40 is not restricted to a symmetric structure.

One of the first end 401 and the second end 402 is the feeding end. At least one of the first end 401 and the second end 402 has at least a plug-foot 40a, and the plug-foot 40a is used for plugging into the inserting hole of a circuit board. For example, as shown in FIG. 3A, the first end 401 and the second end 402 both have the plug-foot 40a. The first end 401 and the second end 402 vertical to the radiating portion 40 is used to make the metal plate antenna 4 stand on the circuit board (not shown in FIG. 3A).

The mentioned grounding pins (41 and 42) are vertical connected to a side 403 of the radiating portion 40. One of the grounding pins (41 and 41) is used for connecting with the grounding of the circuit board. As shown in FIG. 3A, the grounding pins comprises a first grounding pin 41 and a second grounding pin 42. The first grounding pin 41 and the second grounding pin 42 are configured on two sides of the symmetry axis X of the radiating portion 40 respectively. In other words, the first grounding pin 41 and the second grounding pin 42 are configured on two sides of the symmetry axis X, and have the same distance from the symmetry axis X. The first grounding pin 41 may have a plug-foot 41a, and the second grounding pin 42 may have a plug-foot 42a. However, the plug-foots 41a and 42a of the first grounding pin 41 and the grounding pin 42 could be omitted. The grounding pin (41 or 42) could be used to impedance matching of the metal plate antenna 4.

Please refer to FIG. 3A in conjunction with FIG. 3B. FIG. 3B shows a side view drawing of a metal plate antenna according to an embodiment of the instant disclosure. In an embodiment of the instant disclosure, a side 404 of the metal plate antenna 4 may be connected with an extending portion 405, and the extending portion 405 is perpendicular to the radiating portion 40. The extending portion 405 may increase the bandwidth of the antenna. The shape of the extending portion 405 is not restricted thereto. In practical applications, the metal plate antenna 4 may be integrally molded. The first end 401, the second end 402, the grounding pin (41, 42) and the extending portion 405 may be integrally molded by a single metal plate. However, the instant disclosure does not limit that the first end 401, the second end 402, the grounding pin (41, 42) and the extending portion 405 are made by a single metal plate. The metal plate antenna 4 may be assembled by a plurality of metal plates, in which the assembly process may be wielding or mechanical engagement, for example. The material of the used metal plate may be iron, stainless steel or copper, but the present invention is not so restricted.

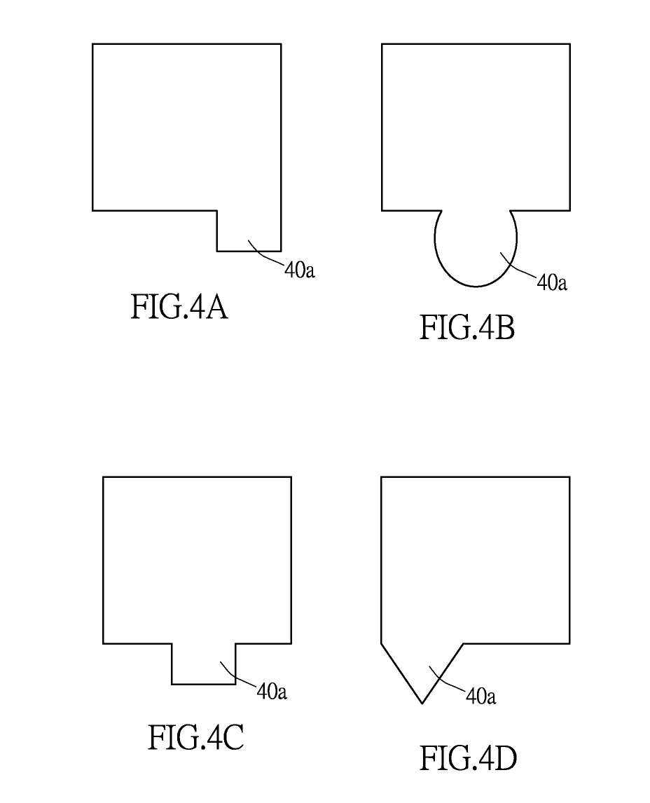

Please refer to FIG. 3A in conjunction with FIG. 4A, FIG. 4B, FIG. 4C and FIG. 4D. FIG. 4A, FIG. 4B, FIG. 4C and FIG. 4D show schematic diagrams of a plug-foot of the metal plate antenna according to an embodiment of the instant disclosure. The plug-foot 40a shown in FIG. 3A may be L shaped, which is exemplary shown in FIG. 4A. The plug-foot 40a may be convex shaped, which is exemplary shown in FIG. 4B, FIG. 4C and FIG. 4D. However, the plug-foot 40a is not restricted thereto. The plug-foot 40a is used to help the metal plate antenna 4 to be positioned on the circuit board.

Please refer to FIG. 3A in conjunction with FIG. 3C. FIG. 3C shows a schematic diagram of a metal plate antenna according to another embodiment of the instant disclosure. The metal plate antenna 5 comprises radiating portion 50 and at least two grounding pins. FIG. 3 shows four grounding pins 51, 52, 53 and 54. Two ends of the radiating portion 50 are a first end 501 and a second end 502 respectively, and the first end 501 and the second end 502 are bended towards the same direction and are perpendicular to the radiating portion 50. The metal plate antenna 5 is significantly identical to the metal plate antenna 4 shown in FIG. 3A except for differences specified in the follows. The shape of the radiating portion 50 and the number of the grounding pins are different. Only the second end 502 has two plug-foots 50a, and the plug-foot of the first end 501 is omitted. In other words, for practical applications, at least a plug-foot 50a for positioning is needed for at least one of the first end 501 and the second end 502. Further, four grounding pins 51, 52, 53 and 54 could be selected to be utilized for impedance matching according to the different positions of the antenna on the antenna module. The number of the grounding pins and the position of the grounding pins which can be determined arbitrarily as needed are not so restricted.

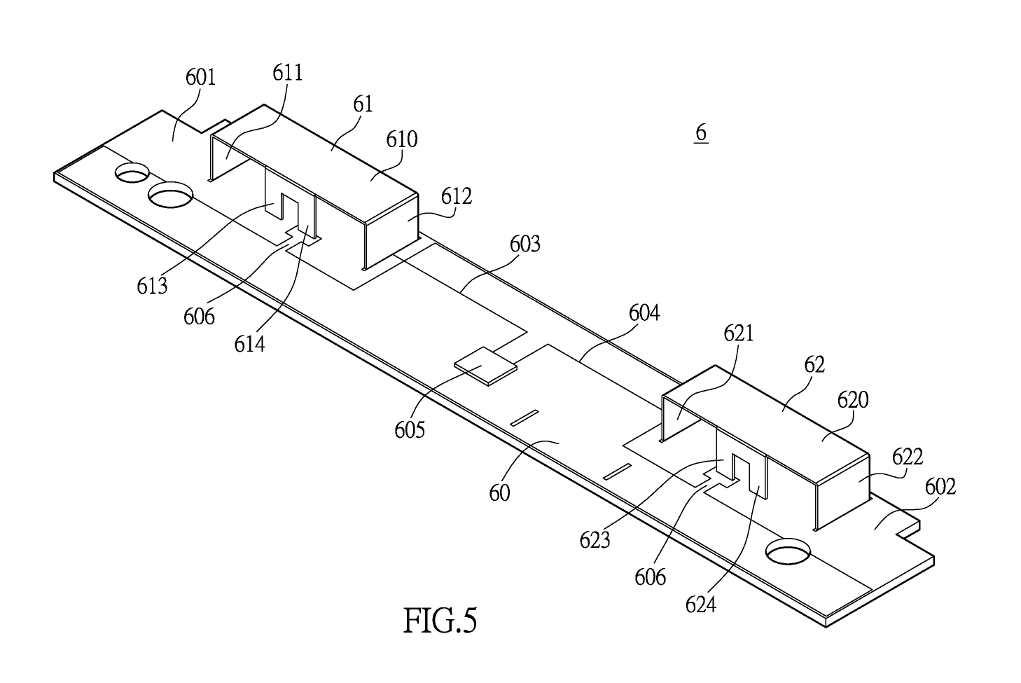

Please refer to FIG. 3A in conjunction with FIG. 5. FIG. 5 shows a schematic diagram of a dual-antenna module according to an embodiment of the instant disclosure. The dual-antenna module 6 comprises a circuit board 60, a first metal plate antenna 61 and a second metal plate antenna 62. The first metal plate antenna 61 and the second metal plate antenna 62 could be the metal plate antenna 4 shown in FIG. 3A.

The circuit board 60 has a first antenna region 601, a second antenna region 602, traces (or so called feeding lines) 603 and 604, an integrated circuit 605, a grounding trace 606 and inserting holes (not shown in the figure). In this embodiment, the first antenna region 601 and the second antenna region 602 are symmetrical to each other, but the present invention is not so restricted.

The first metal plate antenna 61 is disposed in the first antenna region 601, and the first metal plate antenna 61 comprises a radiating portion 610 and at least two grounding pins (referred to the first grounding pin 613 and the second grounding pin 614 shown in FIG. 5). The radiating portion 610 is a metal plate, and two ends of the radiating portion 610 are a first end 611 and a second end 612 respectively. The first end 611 and the second end 612 are bended towards the same direction and are perpendicular to the radiating portion 610. The second end 612 is used for the feeding end. At least one of the first end 611 and the second end 612 has at least a plug-foot, and the plug-foot is used for plugging into the inserting hole of a circuit board. FIG. 5 does not show the plug-foot and the inserting hole, because the plug-foot is inserted to the circuit board 60 in FIG. 5. Please refer to the descriptions of the plug-foot in the previous embodiment. These at least two grounding pins (613, 614) are vertically connected to the radiating portion 610, and one of the two grounding pins (613, 614) is use to connected with the grounding trace 606 of the circuit board 60. As shown in FIG. 5, the second grounding pin 614 of the first metal plate antenna 61 is connected with the grounding trace 606. Please refer to descriptions of previous embodiments for further understanding about details of the first metal plate antenna 61 and the second metal plate antenna 62, the redundant information is not repeated.

The second metal plate antenna 62 is the same as to the first metal plate antenna 61. The second metal plate antenna 62 is disposed in the second antenna region 602, and the second metal plate antenna 62 comprises a radiating portion 620 and at least two grounding pins (referred to the first grounding pin 623 and the second grounding pin 624 shown in FIG. 5). As shown in FIG. 5, the first grounding pin 623 of the second metal plate antenna 62 is connected with the grounding trace 606. Two ends of the radiating portion 620 are a first end 621 and a second end 622 respectively. The first end 621 and the second end 622 are bended towards the same direction and are perpendicular to the radiating portion 620. The first end 621 is used for the feeding end.

Please refer to FIG. 5 again. When the second metal plate antenna 62 and the first metal plate antenna 61 are connected to the circuit board 60, the feeding ends and the grounded grounding pins of these two antennas are both not the same. In this embodiment, the second end 612 of the first metal plate antenna 61 is the feeding end. On the other hand, the first end 611 of the second metal plate antenna 62 is the feeding end. In another embodiment, when the feeding end of the first metal plate antenna 61 is decided as the first end 611, the feeding end of the second metal plate antenna 62 is therefore decided as the second end 622. In other words, one of the first end and the second end could be selected as the feeding end of the first metal plate antenna 61, meanwhile, the other of the first end and the second end is the feeding end of the second metal plate antenna 62.

Please refer to FIG. 3A in conjunction with FIG. 5 again. It is worth mentioning that, in this embodiment, the first grounding pin 613 and the second grounding pin 614 of the first metal plate antenna 61 are symmetrical to each other in the reference of the symmetry axis X. The first end 611 and the second end 612 are symmetrical to each other too. In the same way, the first grounding pin 623 and the second grounding pin 624 of the second metal plate antenna 62 are symmetrical to each other in the reference of the symmetry axis X. The first end 621 and the second end 622 are symmetrical to each other too. The first metal plate antenna 61 and the second metal plate antenna 62 disposed on the circuit board 60 form planar inverted-F antennas (PIFA). As shown in FIG. 5, the second end 612 of the first metal plate antenna 61 is regarded as the feeding end, and the second end 612 is connected with the trace 603 (which is the feeding network). The first end 621 of the second metal plate antenna 62 is regarded as the feeding end, and the second end 612 is connected with the trace 604 (which is the feeding network). The grounding of the first metal plate antenna 61 is implemented by the second grounding pin 614, and the grounding of the second metal plate antenna 62 is implemented by the first grounding pin 623.

Please refer to FIG. 5 again. The second grounding pin 614 and the first grounding pin 623 which are close to the feeding end (compared to the first grounding pin 613 and the second grounding pin 624) are selected to be connected with the grounding trace 606. Meanwhile, the first grounding pin 613 and the second grounding pin 624 are not connected to the grounding trace 606. Therefore, the excited current path on the first metal plate antenna 61 and the excited current path on the second metal plate antenna 62 are symmetrical to each other, thus it is easier to be make the radiation pattern of the first metal plate antenna 61 and the radiation pattern of the second metal plate antenna 62 would be symmetrical to each other. In another embodiment, the first grounding pin 613 and the second grounding pin 624 could be connected to the grounding trace 606; meanwhile, the second grounding pin 614 and the first grounding pin 623 are not grounded. Thus, the excited current path on the first metal plate antenna 61 and the excited current path on the second metal plate antenna 62 are symmetrical to each other. For the antenna design, the impedance of the two antennas could be well matched through selecting the proper grounding pin, thus the dual-antenna module could achieved by two shared antennas. When the disposed position of the antenna is changed, the characteristics of the antenna may not have quite large differences accordingly.

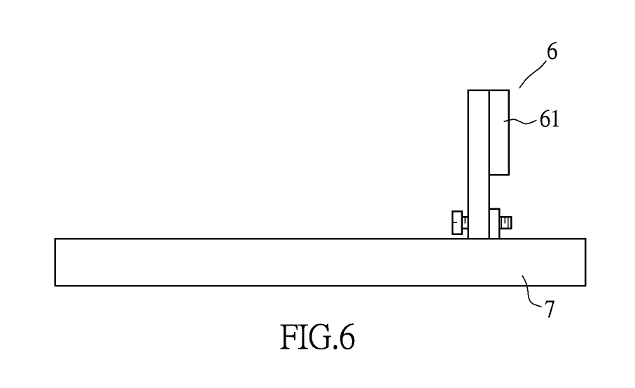

Please refer to FIG. 6 showing a side view drawing of the dual- antenna module shown in FIG. 5 installed to a metal back plate. The dual-antenna module 6 could be installed to a metal back plate 7 of a TV. As shown in FIG. 6, the dual-antenna module 6 is vertically standing on the metal back plate 7.

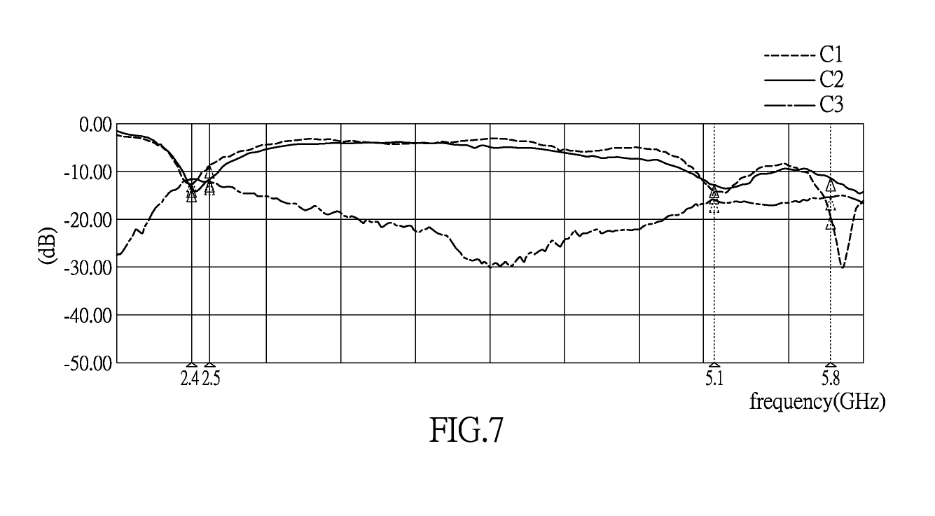

Please refer to FIG. 7 showing a frequency response of S-parameters for the dual-antenna module shown in FIG. 5. The curve C1 is the S11 corresponding to the first metal plate antenna 61. The curve C2 is the S22 corresponding to the metal plate antenna 62. The metal plate antenna 61 and the metal plate antenna 62 could achieve the dual-band operations in 2.4 GHz and 5 GHz in accordance with the operation bands of IEEE 802.11a/b/g/n. The curve C3 is the isolation between the first metal plate antenna 61 and the second metal plate antenna 62. Good isolation between the first metal plate antenna 61 and the second metal plate antenna 62 is achieved.

According to above descriptions, the metal plate antenna provides at least two feeding ends to be selected when the metal plate antenna is placed at different position on the circuit board. One of the grounding pins is selected to achieve proper impedance matching according to the position of the antenna on the circuit board. When the antenna is applied to dual-antenna system, two identical antennas could be used, and one of the antennas does not need to be rotated before disposing on the circuit board. The design of circuit layout could be easier and the manufacturing costs could be reduced too. The structure of the metal plate antenna is simple, and the radiating portion is a sheet of metal plate which improves the recognition rate of the SMT equipment. In the manufacturing process of the antenna, differing from the conventional dual-antenna module utilizing two sets of antenna molds and packages, only a mold for the antenna is needed in the present invention. The disclosed metal plate antenna only needs a set of tray during manufacturing, thus the manufacturing costs could be significantly reduced. According to the improvement of the disclosed antenna, two ends of the antenna could have vertical metal plane (due to the bendings of the first end and the second end) cooperated with the plug-foot, thus the soldering defect rate of the conventional metal plate during SMT process could be decreased. With multiple grounding pins of the disclosed antenna, the consistency of antenna characteristics could be obtained even the antenna is disposed on different positions; meanwhile, the purpose of the sharing antenna is achieved.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A metal plate antenna, comprising:
a radiating portion, being a metal plate, two ends of the radiating portion being a first end and a second end respectively, the first end and the second end being bended towards the same direction and being perpendicular to the radiating portion, one of the first end and the second end being the feeding end, wherein at least one of the first end and the second end has at least a plug-foot, the plug-foot is used for plugging into the inserting hole of a circuit board; and
at least two grounding pins, vertical connected to the radiating portion, one of the grounding pins being used for connecting with the grounding of the circuit board.

2. The metal plate antenna according to claim 1, wherein the radiating portion is symmetry in the reference of the symmetry axis of the radiating portion, the two symmetrical ends are the first end and the second end respectively.

3. The metal plate antenna according to claim 1, wherein the at least two grounding pins comprising a first grounding pin and a second grounding pin, the first grounding pin and the second grounding pin are configured on two sides of the symmetry axis of the radiating portion respectively.

4. The metal plate antenna according to claim 1, wherein the plug-foot is L shaped or convex shaped.

5. The metal plate antenna according to claim 1, wherein the metal plate antenna is integrally molded.
